(19) United States
(12) Patent Application Publication
(10) Pub. No.: US 2023/0416434 A1
(43) Pub. Date: Dec. 28, 2023

(54) LIGHT-CURABLE RESIN COMPOSITION, FORMED RESIN PRODUCT, METHOD FOR PRODUCING MOLD AND METHOD FOR PRODUCING CASTED METAL PRODUCT

(71) Applicant: DIC Corporation, Tokyo (JP)

(72) Inventors: Kousuke IGAWA, Chiba (JP); Shigetoshi NISHIZAWA, Chiba (JP)

(73) Assignee: DIC Corporation, Tokyo (JP)

(21) Appl. No.: 18/035,285

(22) PCT Filed: Nov. 4, 2021
(86) PCT No.: PCT/JP2021/040521

§ 371 Date: May 3, 2023

(30) Foreign Application Priority Data
Nov. 5, 2020 (JP) 2020-184983

(51) Int. Cl. C08F 220/26; C08F 2/48; B22C 9/02

(52) U.S. Cl. CPC C08F 220/26; C08F 2/48; B22C 9/02

(57) ABSTRACT

An object of the present invention is to provide a light-curable resin composition having reduced soot residue at the time of mold preparation and reduced occurrence of cracks and fractures. The present invention has found that a light-curable resin composition including a (meth)acrylate-based UV-curable resin (A) (with proviso that the following compound (B) is omitted), and a compound (B) having an alkylene glycol skeleton represented by a specific chemical formula in a structure allows the soot residue at the time of mold preparation to be reduced and occurrence of cracks and fractures to be reduced, whereby the above object is achieved.

### TECHNICAL FIELD

The present invention relates to a light-curable resin composition used for forming a three-dimensional formed product, a cured product, a formed resin product, and a method for producing a mold.

### BACKGROUND ART

Methods such as machining and casting are commonly used at the time of producing the molded products of metal materials. Of these methods, the casting method can produce metal parts and metal products having complex shapes.

As the casting method, a lost wax method for forming the prototype model of a casted product using a wax or a resin, embedding the prototype model in a embedding material, forming a void space in the embedding material by melting-removing, decomposing-removing, or calcinating-removing the prototype model by heating the prototype model and the embedding material after the embedding material is cured, and pouring a melted metal using this void space as a mold to cast the melted metal and the other methods has been known. The lost wax method is used in the fields of jewelry and dental technology.

Recently, forming the prototype model for the lost wax method with a light-curable resin composition using a 3D printer has been developed (PTL 1).

### CITATION LIST

### Patent Literature

PTL 1: Japanese Unexamined Patent Application No. 2018-048312

### SUMMARY OF INVENTION

### Technical Problem

However, the prototype model formed with a conventional light-curable resin composition has problems in that the surface of the cast product deteriorates by residues such as soot remaining in the embedding material due to insufficient vanishing properties at the time of heating and cracks or fractures are generated in the embedding material due to a difference in expansion rates between the resin used for the prototype model and the embedding material.

An object of the present invention is to provide a light-curable resin composition having reduced soot residue at the time of mold preparation and reduced occurrence of cracks and fractures.

### Solution to Problem

In response to these problems, the inventors of the present invention have found that a light-curable resin composition including a (meth)acrylate-based UV-curable resin (A) (with proviso that the following compound (B) is omitted) and a compound (B) having an alkylene glycol skeleton represented by Formula (1) in a structure:

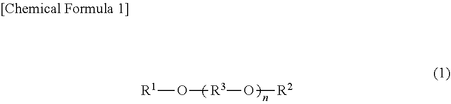

(in Structural Formula (1), R¹ and R² are independently a hydrogen atom, a hydrocarbon group having a carbon number of 1 to 10, or a (meth)acryloyl group; R³ is an alkylene group; and n is an integer of 1 to 100) provides excellent vanishing property at the time of mold preparation and less expansion force at the time of temperature rising and have accomplished the present invention.

In other words, the present invention includes the following aspects
[1] A light-curable resin composition comprising a (meth)acrylate-based UV-curable resin (A) (with proviso that the following compound (B) is omitted) and; a compound (B) having an alkylene glycol skeleton represented by Formula (1) in a structure:

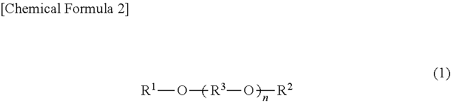

(in Structural Formula (1), R¹ and R² are independently a hydrogen atom, a hydrocarbon group having a carbon number of 1 to 10, or a (meth)acryloyl group; R³ is an alkylene group; and n is an integer of 1 to 100).
[2] The light-curable resin composition as described in [1], in which the compound (B) having the alkylene glycol skeleton in the structure has a (meth)acryloyl group in the structure.
[3] The light-curable resin composition as described in [1] or [2], in which the (meth)acrylate-based UV curable resin (A) comprises a bisphenol-based UV curable resin represented by

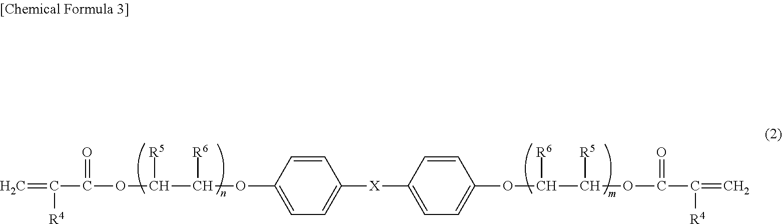

where R⁴, R⁵, and R⁶ are independently a hydrogen atom or a methyl group, X is —O—, —SO₂—, or a partial structure represented by a structural formula of Formula (3):

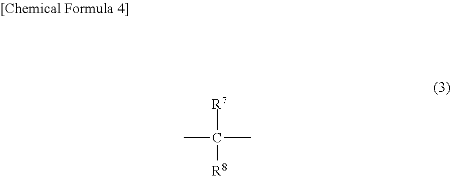

where m and n each independently represent an integer of 1 or more; and m+n is 2 to 40, and in Structural Formula (3), R⁷ and R⁸ are each independently a hydrogen atom or a hydrocarbon group having a carbon number of 1 to 10.
[4] A formed resin product formed by light-curing the light-curable resin composition as described in any one of [1] to [3].
[5] A method for producing a mold, the method comprising: (1) partially or fully embedding the formed resin product as described in [4] with an embedding material, (2) curing or solidifying the embedding material, and (3) melting-removing, decomposing-removing, and/or incinerating-removing the formed resin product.
[6] A method for producing a casted metal product, the method comprising: (4) pouring a metal material into the mold obtained by the method for producing as described in [5] and solidifying the metal material.

### Advantageous Effects of Invention

According to the present invention, a light-curable resin composition having reduced soot residue at the time of mold preparation and reduced occurrence of cracks and fractures can be provided.

### DESCRIPTION OF EMBODIMENTS

Hereinafter, several embodiments of the present invention will be described in detail. The present invention, however, is not limited to the following embodiments. Hereafter, “% by mass” in the present specification means a ratio in the case where the entire light-curable resin composition is determined to be 100% by mass.

The (meth)acrylate-based UV-curable resin (A) used in the present invention is a (meth)acrylate UV-curable resin other than the component (B) described below, which may be an acrylate-based monomer, oligomer, or a mixture thereof that cures by light in an UV wavelength range of 1 nm to 450 nm, and is not particularly limited as long as the effects of the present invention are obtained.

Usable examples of the (meth)acrylate UV-curable resin (A) may specifically include monofunctional (meth)acrylates such as methyl (meth)acrylate, ethyl (meth)acrylate, propyl (meth)acrylate, isopropyl (meth)acrylate, butyl (meth)acrylate, sec-butyl (meth)acrylate, isobutyl (meth)acrylate, 2-ethylbutyl (meth)acrylate, n-pentyl (meth)acrylate, hexyl (meth)acrylate, 2-ethylhexyl (meth)acrylate, heptyl (meth)acrylate, n-octyl (meth)acrylate, nonyl (meth)acrylate, dodecyl (meth)acrylate, 3-methylbutyl (meth)acrylate, iso-octyl (meth)acrylate, lauryl (meth)acrylate, tridecyl (meth)acrylate, stearyl (meth)acrylate, isostearyl (meth)acrylate, neopentyl (meth)acrylate, hexadecyl (meth)acrylate, isoamyl (meth)acrylate, isobornyl (meth)acrylate, cyclohexyl (meth)acrylate, tricyclodecane (meth)acrylate, benzyl (meth)acrylate, phenoxy (meth)acrylate, tetrahydrofurfuryl (meth)acrylate, and dioxane glycol (meth)acrylate;

bifunctional (meth)acrylates such as neopentyl glycol hydroxypivalate di(meth)acrylate, propylene oxide-modified glycerin tri(meth)acrylate, 2-hydroxy-3-acryloyloxypropyl (meth)acrylate, tris(hydroxyethyl)isocyanurate di(meth)acrylate, 3,9-bis[1,1-dimethyl-2-(meth)acryloyloxyethyl]-2,4,8,10-tetraoxospiro[5.5]undecane, dioxane glycol di(meth)acrylate, (EO)- or (PO)-modified bisphenol A di(meth)acrylate, (EO)- or (PO)-modified bisphenol E di(meth)acrylate, (EO)- or (PO)-modified bisphenol F di(meth)acrylate, (EO)- or (PO)-modified bisphenol S di(meth)acrylate, and (EO)- or (PO)-modified 4,4′-oxydiphenol di(meth)acrylate;

trifunctional (meth)acrylates such as EO-modified glycerol tri(meth)acrylate, PO-modified glycerol tri(meth)acrylate, pentaerythritol tri(meth)acrylate, EO-modified phosphoric acid tri(meth)acrylate, trimethylolpropane tri(meth)acrylate, caprolactone-modified trimethylolpropane tri(meth)acrylate, HPA-modified trimethylolpropan tri(meth)acrylate, (EO)- or (PO)-modified trimethylolpropane tri(meth)acrylate, alkyl-modified dipentaerythritol tri(meth)acrylate, and tris(acryloxyethyl)isocyanurate;

tetrafunctional (meth)acrylates such as ditrimethylolpropane tetra(meth)acrylate, pentaerythritol ethoxy tetra(meth)acrylate, and pentaerythritol tetra(meth)acrylate;

pentafunctional (meth)acrylates such as dipentaerythritol hydroxy penta(meth)acrylate and alkyl-modified dipentaerythritol penta(meth)acrylate; and

hexafunctional (meth)acrylates such as dipentaerythritol hexa(meth)acrylate. These compounds may be used singly or may be used by mixing as appropriate for adjusting curing properties, a viscosity, and the like. As the (meth)acrylate-based UV-curable resin (A) used in the present invention, a bisphenol-based UV-curable resin is preferably used due to providing excellent curability.

As the (meth)acrylate UV-curable resin (A) used in the present invention, the bisphenol-based UV-curable resin is preferable as described above. Use of the bisphenol-based UV curable resin represented by Formula (2):

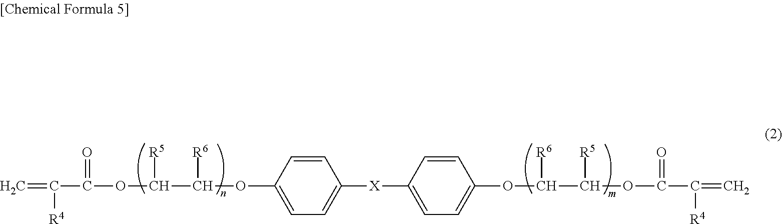

in which R⁴, R⁵, and R⁶ are independently a hydrogen atom or a methyl group; X is —O—, —SO₂—, or a partial structure represented by a structural formula of Formula (3):

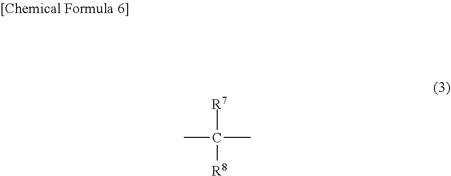

where m and n are each independently an integer of 1 or more, and m+n is 2 to 40; and in Structural Formula (3), R⁷ and R⁸ are each independently a hydrogen atom or a hydrocarbon group having a carbon number of 1 to 10 allows the toughness and strength of a three-dimensional formed product to be improved and excellent curability to be obtained, which is particularly preferable.

The bisphenol-based UV curable resin having m+n (a modified amount) in Formula (2) of 2 or more allows the toughness and strength of the three-dimensional formed product to be improved. From a similar viewpoint, m+n may be 4 or more or 6 or more. In addition, m+n may be 40 or less and is preferably 30 or less. In the case where the UV curable resin (A) includes a plurality of kinds of the modified bisphenol A dimethacrylates represented by Formula (2) having different m+n, the average of m+n may be 2 to 40. As long as the effects of the present invention are obtained, the UV curable resin (A) may be used by adding other UV curable resins as a photopolymerizable component.

As the UV curable resin (A) used in the present invention, for example, UV curable resins sold under the names as commercial names of MIRAMER M240, MIRAMER M241, MIRAMER M244, MIRAMER M249, MIRAMER M2100, MIRAMER M2101, MIRAMER M2200, MIRAMER M2300, and MIRAMER M2301 (all of them are product names and are manufactured by Miwon Specialty Chemical Co., Ltd.) can be used.

The content of the UV curable resin (A) in the present invention is not particularly limited as long as the effects of the present invention are obtained. In the resin composition for stereolithography, the content of the UV curable resin (A) is preferably 20% by mass or more and 80% by mass or less because the strength of the formed product is excellent in addition to reduced soot residue, more preferably 30% by mass or more and 70% by mass or less because the elastic modulus and the toughness of the formed product are improved, and particularly preferably 40% by mass or more and 60% by mass or less because a degree of forming accuracy is improved.

The compound (B) having an alkylene glycol skeleton in the structure used in the present invention is not particularly limited as long as the effects of the present invention are obtained when the compound (B) is a compound represented by Formula (1). A combination of a plurality of compounds may be used.

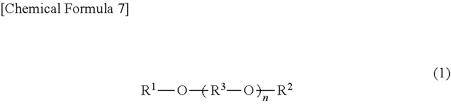

(In Structural Formula (1), R¹ and R² are independently a hydrogen atom, a hydrocarbon group having a carbon number of 1 to 10, or a (meth)acryloyl group; R³ is an alkylene group; and n is an integer of 1 to 100). Specific examples of the compound (B) having the alkylene glycol skeleton in the structure include polyethylene glycol (hereinafter, abbreviated as PEG), poly propylene glycol (hereinafter, abbreviated as PPG), polytetramethylene glycol, ethylene glycol, diethylene glycol, triethylene glycol, 1,3-propylene glycol, 1,2-propylene glycol, dipropylene glycol, tripropylene glycol, neopentyl glycol, 1,3-butanediol, 2,3-butanediol, 1,4-butanediol, 1,6-hexanediol, 1,8-octanediol, 1,9-nonanediol, 1,10-decanediol, 2,2,4-trimethyl-1,3-pentanediol, 3-methyl-1,5-pentanediol, cyclohexanedimethylol, 1,4-cyclohexanediol, tricyclodecanediimethylol, and ether compounds thereof or (meth)acrylate compounds thereof.

These glycol compounds may be used singly or in combination of two or more of them. And derivatives thereof may be used. Of these glycols, a compound having only hydrogen atoms, carbon atoms, and oxygen atoms in the structure as the compound (B) having the alkylene glycol skeleton in the structure is preferable because flammability is particularly improved. In addition, R³ is preferably a hydrocarbon group having a carbon number of 6 or less from the viewpoint of improving flammability, and a hydrocarbon group having a carbon number of 3 or less is more preferable. The compound (B) having n of 2 or more is preferable from the viewpoint of improving flammability, and n is more preferably 6 or more.

As the compound (B) having the alkylene glycol skeleton represented by Formula (1) in the structure used in the present invention, for example, compounds sold under the names as commercial names of PEG-200, PEG-300, PEG-400, PEG-600, PEG-1000, PEG-1500, PEG-1540, PEG-2000, PEG-4000N, PEG-4000S, PEG-6000P, PEG-6000S, PEG-10000, PEG-20000, PEG-20000P, NEWPOL PP-200, NEWPOL PP-400, NEWPOL PP-950, NEWPOL PP-1000, NEWPOL PP-1200, NEWPOL PP-2000, and NEWPOL PP-4000 (all of them are product names and are manufactured by Mitsui Kasei Co., Ltd), PEG #200, PEG #200T, PEG #300, PEG #400, PEG #600, PEG #1000, PEG #1500, PEG #1540, PEG #2000, PEG #4000, PEG #4000P, PEG #6000, PEG #6000P, PEG #11000, PEG #20000, UNIOL D-250, UNIOL D-400G, UNIOL D-700, UNIOL-D-1000, UNIOL D-1200, UNIOL D-2000, and UNIOL D-4000 (all of them are product names and are manufactured by NOF CORPORATION), Exenol 420, Exenol 720, Exenol 1020, Exenol 2020, and Exenol 3020 (all of the products are product names and are manufactured by AGC Inc.), MIRAMER M220, MIRAMER M221, MIRAMER M222, MIRAMER M231, MIRAMER M232, MIRAMER M233, MIRAMER M235, MIRAMER M270, MIRAMER M280, MIRAMER M281, MIRAMER M282, MIRAMER M283, MIRAMER M284, MIRAMER M286, MIRAMER M2040, and MIRAMER M2053 (all of them are product names and are manufactured by Miwon Specialty Chemical Co., Ltd.), and NK Ester A-200, NK Ester A-400, NK Ester A-600, NK Ester A-1000, NK Ester APG-100, NK Ester APG-200, NK Ester APG-400, NK Ester APG-700, NK Ester APMG-65, NK Ester 2G, NK Ester 3G, NK Ester 4G, NK Ester 9G, NK Ester 14G, NK Ester 23G, NK Ester 3PG, and NK Ester 9PG (all of them are product names and are manufactured by SHIN-NAKAMURA CHEMICAL CO., LTD.) can be used.

The content of the compound (B) having the alkylene glycol skeleton represented by Formula (1) in the structure in the present invention is not particularly limited as long as the effects of the present invention are obtained. In the resin composition for stereolithography, the content of the compound (B) is preferably 1% by mass or more and 80% by mass or less because the soot residue is reduced, more preferably 10% by mass or more and 70% by mass or less because the toughness of the formed product is improved, and particularly preferably 20% by mass or more and 60% by mass or less because a degree of forming accuracy is improved.

A method for producing the UV curable resin composition is not particularly limited and the UV curable resin composition may be produced by any methods.

The UV curable resin composition according to the present invention can also include various additives such as photopolymerization initiators, UV absorbers, antioxidants, polymerization inhibitors, silicone-based additives, fluorine-based additives, silane coupling agents, phosphate ester compounds, organic fillers, inorganic fillers, rheology-control agents, defoaming agents, and coloring agents, if necessary.

Examples of the photopolymerization initiators include 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and thioxanthone derivatives, 2,2′-dimethoxy-1,2-diphenylethan-1-one, 2,4,6-trimethylbenzoyldiphenylphosphine oxide, bis(2,4,6-trimethylbenzoyl)phenylphosphine oxide, 2-methyl-1-(4-methylthiophenyl)-2-morpholinopropan-1-one, and 2-benzyl-2-dimethylamino-1-(4-morpholinophenyl)-1-butanone. Of these photopolymerization initiators, phosphorus compounds are preferable because reactivity with (meth)acrylate compounds is excellent, the amount of unreacted (meth)acrylate compounds in the obtained cured product is small, and the cured product having excellent biological safety is obtained. Specifically, 2,4,6-trimethylbenzoyldiphenylphosphine oxide and bis(2,4,6-trimethylbenzoyl)phenylphosphine oxide are preferable. These photopolymerization initiators can be used singly or in combination of two or more of them.

Examples of other commercially available photopolymerization initiators include “Omnirad-1173”, “Omnirad-184”, “Omnirad-127”, “Omnirad-2959” Omnirad-369”, “Omnirad-379”, “Omnirad-907”, “Omnirad-4265”, “Omnirad-1000”, “Omnirad-651”, “Omnirad-TPO”, “Omnirad-819”, “Omnirad-2022”, “Omnirad-2100”, “Omnirad-754”, “Omnirad-784”, “Omnirad-500”, and “Omnirad-81” (manufactured by IGM Resins B.V.), “KAYACURE-DETX”, “KAYACURE-MBP”, “KAYACURE-DMBI”, “KAYACURE-EPA”, and “KAYACURE-OA” (manufactured by Nippon Kayaku Co.), “VICURE-10” and “VICURE-55” (manufactured by Stouffer Chemical Company), Trigonal P1 (manufactured by Akzo Nobel N.V.), Sandoray 1000 (manufactured by SANDOZ Co., LTD.), DEAP (manufactured by Upjohn Co.), Quantacure-PDO, Quantacure-ITX, and Quantacure-EPD (manufactured by Ward, Blenkinsop and Co., Ltd.), and Runtecure 1104” (manufactured by Runtec Co.). Of these photopolymerization initiators, “Omnirad-TPO” and “Omnirad-819” are preferable because reactivity with the (meth)acrylate compounds is excellent, the amount of unreacted (meth)acrylate compounds in the obtained cured product is small, and the cured product having excellent biological safety is obtained.

The amount of the added photopolymerization initiator is preferably used in a range of 0.1% by mass or more and 4.5% by mass or less and more preferably used in a range of 0.5% by mass or more and 3% by mass or less in the UV-curable resin composition.

The UV-curable resin composition can improve the curability by further adding a photosensitizer, if necessary.

Examples of the photosensitizer include amine compounds such as aliphatic amines and aromatic amines, urea compounds such as o-tolylthiourea, and sulfur compounds such as sodium diethyldithiophosphate and s-benzylisothiuronium-p-toluenesulfonate.

Examples of the UV absorbers include triazine-derivatives such as 2-[4-{(2-hydroxy-3-dodecyloxypropyl)oxy}-2-hydroxyphenyl]-4,6-bis(2,4-dimethylphenyl)-1,3,5-triazine and 2-[4-{(2-hydroxy-3-tridecyloxypropyl)oxy}-2-hydroxyphenyl]-4,6-bis(2,4-dimethylphenyl)-1,3,5-triazine, 2-(2′-xanthenecarboxy-5′-methylphenyl)benzotriazole, 2-(2′-o-nitrobenzyloxy-5′-methylphenyl)benzotriazole, 2-xanthenecarboxy-4-dodecyloxybenzophenone, and 2-o-nitrobenzyloxy-4-dodecyloxybenzophenone. These UV absorbers can be used singly or in combination of two or more of them.

Examples of the antioxidants include hindered phenol-based antioxidants, hindered amine-based antioxidants, organosulfur-based antioxidants, and phosphate ester-based antioxidants. These antioxidants can be used singly or in combination of two or more of them.

Examples of the polymerization inhibitors include hydroquinone, methoquinone, di-t-butylhydroquinone, p-methoxyphenol, butylhydroxytoluene, and nitrosamine salts.

Examples of the silicone-based additives include polyorganosiloxanes having alkyl groups or phenyl groups such as polydimethylsiloxane, methylphenylpolysiloxane, cyclic dimethylpolysiloxane, methylhydrogenpolysiloxane, polyether-modified dimethylpolysiloxane copolymers, polyester-modified dimethylpolysiloxane copolymers, fluorine-modified dimethylpolysiloxane copolymers, and amino-modified dimethylpolysiloxane copolymers, polydimethylsiloxane having polyether-modified acrylic groups, and polydimethylsiloxane having polyester-modified acrylic groups. These silicone-based additives can be used singly or in combination of two or more of them.

Examples of the fluorine-based additives include “Megaface” series manufactured by DIC Corporation. These fluorine-based additives can be used singly or in combination of two or more of them.

Examples of the silane coupling agents include vinyl-based silane coupling agents such as vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, special aminosilanes, 3-ureidopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanetopropyltriethoxysilane, allyltrichlorosilane, allyltriethoxysilane, allyltrimethoxysilane, diethoxymethylvinylsilane, vinyltrimethoxysilane, vinyltriethoxysilane, and vinyltris(2-methoxyethoxy)silane;

Epoxy-based silane coupling agents such as diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane;

styrene-based silane coupling agents such as p-styryltrimethoxysilane;

(meth)acryloxy-based silane coupling agents such as 3-methacryloxypropylmethyldimethoxysilane, 3-acryloxypropyltrimethoxysilane, 3-methacryloxypropyltrimethoxysilane, 3-methacryloxypropylmethyldiethoxysilane, and 3-methacryloxypropyltriethoxysilane;

amino-based silane coupling agents such as N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane;

ureido-based silane coupling agents such as 3-ureidopropyltriethoxysilane;

chloropropyl-based silane coupling agents such as 3-chloropropyltrimethoxysilane;

mercapto-based silane coupling agents such as 3-mercaptopropylmethyldimethoxysilane and 3-mercaptopropyltrimethoxysilane;

sulfide-based silane coupling agents such as bis(triethoxysilylpropyl)tetrasulfide; and

isocyanate-based silane coupling agents such as 3-isocyanetopropyltriethoxysilane. These silane coupling agents can be used singly or in combination of two or more of them.

Examples of the phosphate ester compounds include compounds having (meth)acryloyl groups in the molecular structure. Examples of commercially available products include “Kayama-PM-2” and “Kayama-PM-21” manufactured by Nippon Kayaku Co., Ltd., “Light Ester P-1M”, “Light Ester P-2M”, and “Light Acrylate P-1A(N)” manufactured by Kyoeisha Chemical Co., Ltd., “SIPOMER PAM 100”, “SIPOMER PAM 200”, “SIPOMER PAM 300”, and “SIPOMER PAM 4000” manufactured by Solvay S. A., “Viscote #3PA” and “Viscote #3PMA” manufactured by Osaka Organic Chemical Industry, and “NEW FRONTIER S-23A” manufactured by DKS Co. Ltd. Examples of phosphate compounds having allyl ether groups in the molecular structure include “SIPOMER PAM 5000” manufactured by SOLVAY S. A.

Examples of the organic fillers include solvent-insoluble materials derived from plants such as cellulose, lignin, and cellulose nanofibers and organic beads such as polymethyl methacrylate beads, polycarbonate beads, polystyrene beads, polyacrylstyrene beads, silicone beads, glass beads, acrylic beads, benzoguanamine resin-based beads, melamine resin-based beads, polyolefin-based resin beads, polyester-based resin beads, polyamide resin beads, polyamide-based resin beads, polyfluoroethylene resin beads, and polyethylene resin beads. These organic fillers can be used singly or in combination of two or more of them.

Examples of the inorganic fillers include inorganic fine particles such as silica, alumina, zirconia, titania, barium titanate, and antimony trioxide. These inorganic fillers can be used singly or in combination of two or more of them. The average particle diameter of the inorganic fine particles is preferably in the range of 95 nm to 250 nm and particularly preferably in the range of 100 nm to 180 nm.

In the case where the inorganic particles are included, dispersion aids can be used. Examples of the dispersion aids include phosphate ester compounds such as isopropyl acid phosphate, triisodecylphosphite, and ethylene oxide-modified phosphoric acid dimethacrylate. These dispersion aids can be used singly or in combination of two or more of them. Examples of the commercially available products of the dispersion aids include “Kayama-PM-21” and “Kayama-PM-2” manufactured by Nippon Kayaku Co., Ltd. and “Light Ester P-2M” manufactured by Kyoeisha Chemical Co., Ltd.

Examples of the rheology-control agents include amide waxes such as “Dispalon 6900” manufactured by Kusumoto Chemicals, Ltd.; urea-based rheology-control agents such as “BYK410” manufactured by BYK-Chemie GmbH; polyethylene waxes such as “Dispalon 4200” manufactured by Kusumoto Chemicals, Ltd., and cellulose acetate butyrates such as “CAB-381-2” and “CAB 32101” manufactured by Eastman Chemical Products, Inc.

Examples of the defoaming agents include oligomers containing fluorine atoms or silicon atoms, higher fatty acids, or oligomers such as acrylic polymers.

Examples of the coloring agents include pigments and dyes.

As the pigments, inorganic pigments and organic pigments that are known and customary can be used.

Examples of the inorganic pigments include titanium dioxide, antimony red, red iron oxide, cadmium red, cadmium yellow, cobalt blue, Prussian blue, ultramarine blue, carbon black, and graphite.

Examples of the organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perynone pigments, quinophthalone pigments, anthraquinone pigments, thioindigo pigments, benzimidazolone pigments, and azo pigments. These pigments can be used singly or in combination of two or more of them.

Examples of the dyes include azo dyes such as monoazo dyes and diazo dyes, metal complex dyes, naphthol dyes, anthraquinone dyes, indigo dyes, carbonium dyes, quinimine dyes, cyanine dyes, quinoline dyes, nitro dyes, nitroso dyes, benzoquinone dyes, naphthoquinone dyes, naphthalimide dyes, perinone dyes, phthalocyanine dyes, and triallylmethane dyes. These dyes can be used singly or in combination of two or more of them.

The formed resin product according to the present invention is formed by curing the UV-curable resin composition.

The formed resin product can be obtained by irradiating the UV-curable resin composition with UV light. In order to efficiently performing the curing reaction by UV light, the UV-curable resin composition may be irradiated under an inert gas atmosphere such as nitrogen gas or under an air atmosphere.

UV lamps are commonly used as a source of UV light generation source from the viewpoint of practical and economic reasons. Specific examples include low-pressure mercury lamps, high-pressure mercury lamps, super high-pressure mercury lamps, xenon lamps, gallium lamps, metal halide lamps, sunlight, and LEDs. Of these UV lamps, LEDs are preferably used as the light source because LEDs provide stable illumination over a long period of time.

The wavelength of the UV light is not particularly limited as long as the wavelength is a wavelength that can cure the UV-curable resin composition according to the present invention and can be selected in the range of 1 nm to 450 nm.

The UV irradiation may be performed in one step or in two or more steps.

The formed resin product according to the present invention can be prepared by known optical stereolithography methods.

Examples of the optical stereolithography methods include a stereolithography (SLA) method, a digital light processing (DLP) method, and an inkjet method.

The stereolithography (SLA) method refers to a method of irradiating a tank of a liquid UV-curable resin composition with the UV light at a point and curing layer by layer while the forming stage is being moved to perform the stereolithography.

The digital light processing (DLP) method refers to a method of irradiating the tank of the liquid UV-curable resin composition with UV light in a plane and curing layer by layer while the forming stage is being moved to perform the stereolithography.

The inkjet stereolithography method refers to a method for ejecting tiny droplets of the UV-curable resin composition from nozzles so as to draw a predetermined shape pattern and then irradiating with UV light to form a cured thin film.

Of these optical stereolithography methods, the DLP method is preferable because the DLP method enables high-speed forming by planes.

The stereolithography method of the DLP method is not particularly limited as long as the method uses a DLP method stereolithography system. As the forming conditions, a stacking pitch of the stereolithography in the range of 0.01 mm to 0.2 mm, an irradiation wavelength in the range of 350 nm to 410 nm, a light intensity in the range of 0.5 mW/cm² to 50 mW/cm², and an integrated light intensity per layer in the range of 1 mJ/cm² to 100 mJ/cm² are required because forming accuracy of three-dimensional formed product becomes excellent. Above all, a stacking pitch of the stereolithography in the range of 0.02 mm to 0.1 mm, an irradiation wavelength in the range of 380 nm to 410 nm, a light intensity in the range of 5 mW/cm² to 15 mW/cm², and an integrated light intensity per layer in the range of 5 mJ/cm² to 15 mJ/cm² are preferable because the forming accuracy of three-dimensional formed product becomes further excellent.

The formed resin product according to the present invention has excellent castability, and thus the burning rate of the three-dimensional formed product is preferably 50% or more under a nitrogen atmosphere at 400° C. In the present invention, the burning rate is a value calculated by [(Initial weight at 25° C.−Weight at each temperature)/(Initial weight at 25° C.)] in thermogravimetric differential thermal analysis (TG-DTA).

The formed resin product according to the present invention can be used, for example, for dental materials, automotive parts, aerospace-related parts, electrical and electronic parts, building materials, interior decorations, jewelries, and medical materials.

Examples of the medical materials include hard resin materials for dentistry such as surgical guides, false teeth, bridges, and orthodontic appliances for dental treatment.

The formed resin product has excellent hardness and castability and thus is suitable for the production of molds using the formed resin product.

Examples of the method of producing the molds include a method including a step (1) of partially or fully embedding the formed resin product according to the invention with an embedding material, a step (2) of hardening or solidifying the embedding material, and a step (3) of melting-removing, decomposing-removing, and/or incinerating-removing the formed resin product.

Examples of the embedding materials include gypsum-based embedding materials and phosphate-based embedding materials. Examples of the gypsum-based embedding materials include silica embedding materials, quartz embedding materials, and cristobalite embedding materials.
The step (1) is a step of partially or fully embedding the three-dimensional formed product with the embedding material. At this step, the embedding material is preferably kneaded with an appropriate amount of water. An excessively high water-mixing ratio results in longer curing time, whereas as excessively low water-mixing ratio results in poor flowability and thus the embedding material is difficult to pour. Applying a surfactant to the three-dimensional formed product allows the embedding material to wet and to be fitted well, and thus roughness on the surface of the casted products is less likely to be apparent. In addition, at the time of embedding the three-dimensional formed product, the three-dimensional formed product is preferably embedded so that air bubbles do not attach to the surface of the casted product.
The step (2) is a step of hardening or solidifying the embedding material. In the case where the gypsum-based embedding material is used as the embedding material, the temperature for solidifying the embedding material is preferably in the range of 200° C. to 400° C. The embedding material is preferably solidified by allowing the embedding material to stand still for about 10 minutes to about 60 minutes after the three-dimensional formed product is embedded.
The process (3) is a step of melting-removing, decomposing-removing, and/or incinerating-removing the three-dimensional formed product. In the case where the three-dimensional formed product is removed by incineration, the incineration temperature is preferably in the range of 400° C. to 1,000° C. and more preferably in the range of 600° C. to 800° C.

A casted metal product can be obtained by pouring a metal material into the mold obtained through the above steps (1) to (3), and solidifying the metal material (a step (4)). This allows the casted metal product corresponding to the prototype of the formed resin product to be produced.

### EXAMPLES

Hereinafter, the present invention will be further specifically described with reference to Examples. The invention, however, is not limited to these Examples. (Hereinafter, “part” described with respect to the amount of each component means “part by mass”).

### Example 1

In a container equipped with a stirrer, 20 parts by mass of bisphenol A ethylene oxide modified (4-mol addition) dimethacrylate, 80 parts by mass of polypropylene glycol 400 dimethacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (1) was obtained.

### Example 2

In a container equipped with a stirrer, 40 parts by mass of bisphenol A ethylene oxide modified (4-mol addition) dimethacrylate, 60 parts by mass of polypropylene glycol 400 dimethacrylate, and 2 parts by mass of a photopolymerization initiator (“Omnirad 819”; 2,4,6-trimethylbenzoyl diphenylphosphine oxide, manufactured by IGM Resins B.V) were blended and the resultant mixture was stirred and mixed for 1 hour while the liquid temperature was controlled to 60° C. to dissolve uniformly, whereby a resin composition for stereolithography (2) was obtained.

### Example 3

In a container equipped with a stirrer, 40 parts by mass of bisphenol A ethylene oxide modified (4-mol addition) dimethacrylate, 60 parts by mass of polypropylene glycol 400 dimethacrylate, 2 parts by mass of a photopolymerization initiator (“Omnirad 819”; 2,4,6-trimethylbenzoyl diphenylphosphine oxide, manufactured by IGM Resins B.V.), and 0.1 parts by mass of a pigment were blended and the resultant mixture was stirred and mixed for 1 hour while the liquid temperature was controlled to 60° C. to dissolve uniformly, whereby a resin composition for stereolithography (3) was obtained.

### Example 4

In a container equipped with a stirrer, 80 parts by mass of bisphenol A ethylene oxide modified (4-mol addition) dimethacrylate, 20 parts by mass of polypropylene glycol 400 dimethacrylate, and 2 parts by mass of a photopolymerization initiator (“Omnirad 819”; 2,4,6-trimethylbenzoyl diphenylphosphine oxide, manufactured by IGM Resins B.V) were blended and the resultant mixture was stirred and mixed for 1 hour while the liquid temperature was controlled to 60° C. to dissolve uniformly, whereby a comparative resin composition for stereolithography (4) was obtained.

### Example 5

In a container equipped with a stirrer, 40 parts by mass of bisphenol A ethylene oxide modified (4-mol addition) dimethacrylate, 60 parts by mass of polypropylene glycol 400 diacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (5) was obtained.

### Example 6

In a container equipped with a stirrer, 40 parts by mass of bisphenol A ethylene oxide modified (4-mol addition) diacrylate, 60 parts by mass of polypropylene glycol 400 dimethacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (6) was obtained.

### Example 7

In a container equipped with a stirrer, 40 parts by mass of bisphenol A ethylene oxide modified (10-mol addition) dimethacrylate, 60 parts by mass of polypropylene glycol 400 dimethacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (7) was obtained.

### Example 8

In a container equipped with a stirrer, 40 parts by mass of bisphenol A ethylene oxide modified (4-mol addition) dimethacrylate, 60 parts by mass of tripropylene glycol dimethacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (8) was obtained.

### Example 9

In a container equipped with a stirrer, 85 parts by mass of bisphenol A ethylene oxide modified (4-mol addition) dimethacrylate, 15 parts by mass of polypropylene glycol 2000, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (9) was obtained.

### Example 10

In a container equipped with a stirrer, 50 parts by mass of bisphenol A ethylene oxide modified (4-mol addition) dimethacrylate, 40 parts by mass of polypropylene glycol 400 dimethacrylate, 10 parts by mass of polypropylene glycol 2000, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a resin composition for stereolithography (9) was obtained.

### Example 11

In a container equipped with a stirrer, 50 parts by mass of bisphenol A ethylene oxide modified (4-mol addition) dimethacrylate, 40 parts by mass of polyipropylene glycol 400 dimethacrylate, 10 parts by mass of polyethylene glycol 2000, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a comparative resin composition for stereolithography (9) was obtained.

### Comparative Example 1

In a container equipped with a stirrer, 100 parts by mass of polypropylene glycol 400 dimethacrylate and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a comparative resin composition for stereolithography (1) was obtained.

### Comparative Example 2

In a container equipped with a stirrer, 80 parts by mass of bisphenol A ethylene oxide modified (10-mol addition) dimethacrylate, 20 parts by mass of neopentyl glycol dimethacrylate, and 2 parts by mass of a photopolymerization initiator (“Omnirad 819”; 2,4,6-trimethylbenzoyl diphenylphosphine oxide, manufactured by IGM Resins B.V.) were blended and the resultant mixture was stirred and mixed for 1 hour while the liquid temperature was controlled to 60° C. to dissolve uniformly, whereby a comparative resin composition for stereolithography (2) was obtained.

With respect to the prepared resin compositions for stereolithography (1) to (11) and the comparative resin compositions for stereolithography (1) and (2), the formed resin products were prepared by the following process and the curability of the prepared resin compositions was evaluated.

(Preparation of Formed Resin Products)

With respect to the resin compositions for stereolithography (1) to (11) and the comparative resin compositions for stereolithography (1) and (2), formed resin products having the predetermined shape were prepared with the light-curable resin compositions using a surface-exposure method (digital light processing: DLP) stereolithography system (DLP printer manufactured by ASIGA). The stacking pitch for stereolithography was 0.05 mm to 0.1 mm, the irradiation wavelength was 400 nm to 410 nm, and the light irradiation time was 0.5 seconds to 20 seconds per layer. The formed resin products formed were ultrasonically cleaned in ethanol, and thereafter the three-dimensional products were post-cured by irradiating the front surface and back surface of the three-dimensional formed products with light using a high-pressure mercury vapor lamp so that the integrated light intensity was 10,000 mJ/cm² to 2,000 mJ/cm².

The following evaluations were performed on the resin compositions for stereolithography (1) to (11) and comparative resin compositions for stereolithography (1) and (2) obtained in Examples and Comparative Examples described above.

(Evaluation of Curability)

Curability: After a formed resin product was formed using a 3D printer, the sensory evaluation of the stickiness of the surface of the ethanol-washed formed resin product was performed by three persons.

### (Evaluation Criteria)

∘ (Three persons evaluated that no stickiness existed)
Δ (One or two persons evaluated that stickiness existed)
x (Three persons evaluated that stickiness existed)

(Evaluation of the Surface of the Formed Product)
Surface smoothness: After a formed resin product was formed using a 3D printer, the sensory evaluation of the surface smoothness of the ethanol-washed formed resin product was performed by three persons.

(Evaluation Criteria)
□ (Three persons evaluated that no surface roughness existed)
∘(One person evaluated that surface roughness existed)
Δ (Two persons evaluated that surface roughness existed)
x (Three person evaluated that surface roughness existed)

[Method for Evaluating Hardness]

For the resin compositions for stereolithography obtained in Examples and Comparative Examples, hardness was measured in accordance with the method described in JIS K 6253-3: 2012 “Rubber, vulcanized or thermoplastic-Determination of hardness-Part 3: Durometer method”.

[Method for Evaluating Burning Rate]

The resin compositions for stereolithography obtained in Examples and Comparative Examples that were crashed into pieces of 5 mg to 6 mg were used as test pieces. Using a simultaneous thermogravimeter-differential thermal analyzer (TG-DTA: TGA/DSC1, manufactured by Mettler-Toledo International Inc.), a mass loss was measured when a temperature was raised from 25° C. to 600° C. at 10° C./minute under a nitrogen atmosphere, and a burning rate at 400° C. was calculated from [(Initial weight at 25° C.−Weight at 400° C.)/(Initial weight at 25° C.)].

### (Evaluation Criteria)

∘ (The burning rate was 50% or more)
Δ (The burning rate was 30% or more and less than 50%)
x (The burning rate was less than 30%)

[Methods for Evaluating Castability].

The three-dimensional formed products obtained in Examples and Comparative Examples were embedded in an embedding material formed by mixing cristobalite embedding material (Sakura Quick 30, manufactured by Yoshino Gypsum Sales Co., Ltd.) and water at a mass ratio of 100:33 and the resultant embedded products were allowed to stand at 25° C. for 30 minutes to solidify the embedding material. Subsequently, the resultant product was heated in an electric furnace heated to 700° C. for 1 hour to incinerate the three-dimensional formed product to prepare a mold. Castability at this process was evaluated visually in accordance with the following criteria. The inside of the mold was visually checked by cutting the mold to determine presence or absence of cracks and cleavages, presence or absence of the residue of the three-dimensional formed product and soot, and good or poor transferability of the three-dimensional formed product to the mold.
∘: No cracks and cleavages existed on the outside or inside of the mold, no residue of the three-dimensional formed product or soot inside the mold existed, and transferability of the three-dimensional formed product to the mold was good.
Δ: Although cracks and cleavages existed inside the mold, no cracks or cleavages existed outside the mold, no residue of the three-dimensional formed product or soot inside the mold existed, and transferability of the three-dimensional formed product to the mold was good.
x: At least one of the cracks and cleavages outside the mold, the residue of the three-dimensional formed product or soot residue inside the mold, and the poor transferability of the three-dimensional formed product to the mold occurred and thus this mold could not be used.

The results of the tests are listed in Table 1 to Table 3.

TABLE 1

| | | Example 1 | Example 2 | Example 3 | Example 4 | Example 5 | Example 6 |
|---|---|---|---|---|---|---|---|
| | | Composition (parts by mass) | | | | | |
| Component A | Bisphenol A ethylene oxide modified (4 mol addition) | | | | | | 40 |
| | diacrylate | | | | | | |
| | Bisphenol A ethylene oxide modified (4 mol addition) | 20 | 40 | 40 | 80 | 40 | |
| | dimethacrylate | | | | | | |
| | Bisphenol A ethylene oxide modified (10 mol addition) | | | | | | |
| | dimethacrylate | | | | | | |
| B Component | Polypropylene glycol 400 dimethacrylate | 80 | 60 | 60 | 20 | | 60 |
| | Tripropylene glycol dimethacrylate | | | | | | |
| | Polypropylene glycol 400 diacrylate | | | | | 60 | |
| | Polyethylene glycol 2000 | | | | | | |
| | Polypropylene glycol 2000 | | | | | | |
| Initiator | Photopolymerization initiator | 2 | 2 | 2 | 2 | 2 | 2 |
| Coloring | Pigment | | | 0.10 | | | |
| agent | | | | | | | |

| | | | | | | |
|---|---|---|---|---|---|---|
| Shore D hardness | 77 | 82 | 82 | 85 | 63 | 80 |
| Curability | Δ | ∘ | ∘ | ∘ | ∘ | ∘ |
| Surface of formed product | Δ | ∘ | ∘ | ∘ | ∘ | ∘ |
| Flammability | ∘ | ∘ | ∘ | Δ | ∘ | ∘ |
| Castability | ∘ | ∘ | ∘ | Δ | ∘ | ∘ |

TABLE 2

| | | Example 7 | Example 8 | Example 9 | Example 10 | Example 11 |
|---|---|---|---|---|---|---|
| | | Composition (parts by mass) | | | | |
| Component A | Bisphenol A ethylene oxide modified (4 mol addition) | | | | | |
| | diacrylate | | | | | |
| | Bisphenol A ethylene oxide modified (4 mol addition) | | 40 | 85 | 50 | 50 |
| | dimethacrylate | | | | | |
| | Bisphenol A ethylene oxide modified (10 mol addition) | 40 | | | | |
| | dimethacrylate | | | | | |
| B Component | Polypropylene glycol 400 dimethacrylate | 60 | | | 40 | 40 |
| | Tripropylene glycol dimethacrylate | | 60 | | | |
| | Polypropylene glycol 400 diacrylate | | | | | |
| | Polyethylene glycol 2000 | | | | | 10 |
| | Polypropylene glycol 2000 | | | 15 | 10 | |
| Initiator | Photopolymerization initiator | 2 | 2 | 2 | 2 | 2 |
| Coloring | Pigment | | | | | |
| agent | | | | | | |

| | | | | | |
|---|---|---|---|---|---|
| Shore D hardness | 65 | 87 | 87 | 79 | 79 |
| Curability | ∘ | ∘ | ∘ | ∘ | ∘ |
| Surface of formed product | ∘ | ∘ | ∘ | □ | □ |
| Flammability | ∘ | Δ | Δ | ∘ | ∘ |
| Castability | ∘ | Δ | Δ | ∘ | ∘ |

TABLE 3

| | | Comparative | Comparative |
|---|---|---|---|
| | | Example 1 | Example 2 |
| | | Composition (parts by mass) | |
| Component | Bisphenol A ethylene oxide modified (4 mol addition) | | |
| A | diacrylate | | |
| | Bisphenol A ethylene oxide modified (4 mol addition) | | 100 |
| | dimethacrylate | | |
| | Bisphenol A ethylene oxide modified (10 mol addition) | | |
| | dimethacrylate | | |
| B | Polypropylene glycol 400 dimethacrylate | 100 | |
| Component | Tripropylene glycol dimethacrylate | | |
| | Polypropylene glycol 400 diacrylate | | |
| | Polyethylene glycol 2000 | | |
| | Polypropylene glycol 2000 | | |
| Initiator | Photopolymerization initiator | 2 | 2 |
| Coloring | Pigment | | |
| agent | | | |

| | | |
|---|---|---|
| Shore D hardness | 72 | 88 |
| Curability | x | ○ |
| Surface of formed product | x | ○ |
| Flammability | ○ | x |
| Castability | ○ | x |

As listed in Table 1 to Table 3, the resin compositions for stereolithography in Examples 1 to 11 exhibited excellent formability and castability. On the other hand, poor curability and soot residue in the casting mold were observed for the resin compositions for stereolithography in Comparative Examples 1 and 2.

1. A light-curable resin composition comprising:
a (meth)acrylate-based UV-curable resin (A) (with proviso that the following compound (B) is omitted); and
a compound (B) having an alkylene glycol skeleton represented by Formula (1) in a structure: 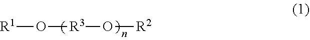
(in Structural Formula (1), R¹ and R² are independently a hydrogen atom, a hydrocarbon group having a carbon number of 1 to 10, or a (meth)acryloyl group; R³ is an alkylene group; and n is an integer of 1 to 100).

2. The light-curable resin composition according to claim 1, wherein the compound (B) having the alkylene glycol skeleton in the structure has a (meth)acryloyl group in the structure.

3. The light-curable resin composition according to claim 1, wherein the (meth)acrylate-based UV-curable resin (A) comprises a bisphenol-based UV curable resin represented by Formula (2): 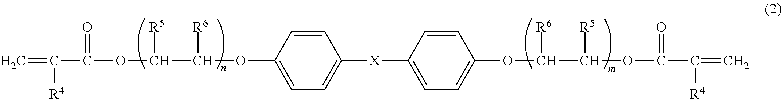
where R⁴, R⁵, and R⁶ are independently a hydrogen atom or a methyl group; X is —O—, —SO₂—, or a partial structure represented by a structural formula of Formula (3); m and n each independently represent an integer of 1 or more, and m+n is 2 to 40: 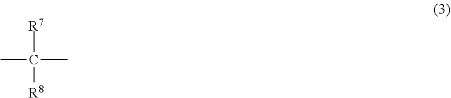
in Structural Formula (3), R⁷ and R⁸ are each independently a hydrogen atom or a hydrocarbon group having a carbon number of 1 to 10.

4. A formed resin product formed by light-curing the light-curable resin composition according to claim 1.

5. A method for producing a mold, the method comprising:
(1) partially or fully embedding the formed resin product according to claim 4 with an embedding material;
(2) curing or solidifying the embedding material; and
(3) melting-removing, decomposing-removing, and/or incinerating-removing the formed resin product.

6. A method for producing a casted metal product, the method comprising (4) pouring a metal material into the mold obtained by the method for producing according to claim 5 and solidifying the metal material.
